(19) United States
(12) Patent Application Publication
(10) Pub. No.: US 2020/0367523 A1
(43) Pub. Date: Nov. 26, 2020

(54) AGENT FOR REDUCING OILINESS OF COOKED FOOD AND METHOD FOR REDUCING OILINESS OF COOKED FOOD

(71) Applicant: J-OIL MILLS, Inc., Tokyo (JP)

(72) Inventors: Takehiko SEKIGUCHI, Tokyo (JP); Jun IMAGI, Tokyo (JP); Anna ASAKURA, Tokyo (JP); Ayato TAKASAKI, Tokyo (JP); Kenichi WATANABE, Tokyo (JP)

(21) Appl. No.: 16/635,190

(22) PCT Filed: Jun. 1, 2018
(86) PCT No.: PCT/JP2018/021203

§ 371 Date: Jan. 30, 2020

(30) Foreign Application Priority Data
Aug. 8, 2017 (JP) 2017-153548

(51) Int. Cl. A23D 9/04; A23L 5/10; A23L 17/00; A23L 19/18; C11B 3/04

(52) U.S. Cl. CPC A23D 9/04; A23L 5/11; A23V 2002/00; A23L 19/18; C11B 3/04; A23L 17/75

(57) ABSTRACT

Provided are an agent for reducing the oiliness of cooked food and a method for reducing the oiliness of cooked food that make it possible to reduce the oiliness of prepared cooked food.

The agent for reducing the oiliness of cooked food contains roasted oil as an active component. The method for reducing the oiliness of cooked food comprises including roasted oil in a cooking oil or fat composition, applying the same to preparation materials, and conducting cooking. The roasted oil is preferably derived from corn or soybeans. The present invention is preferably applied to fried foods.

### TECHNICAL FIELD

The present invention relates to an agent for reducing the oiliness of cooked food and a method for reducing the oiliness of cooked food that are used in preparing tempura, deep-fried foods, and other such foods.

### BACKGROUND ART

Rapeseed oil, soybean oil, corn oil, and other such edible oils or fats are used in the cooking of deep-fried foods, tempura, and other fried foods. Oil content is included in cooked foods that have been prepared using these edible oils or fats. In some situations, a problem is therefore created in that the oiliness of the oil content is unpleasant for consumers.

In response to such a problem, Patent Document 1, for example, discloses an oil or fat composition that includes, in specific blending amounts: a palm-based oil or fat having an iodine value of 35 to 58; a transesterified oil or fat obtained by the transesterification of a mixed oil or fat that includes a fractionated palm oil having an iodine value of 25 to 35 and a liquid oil having an iodine value of 100 to 130 in a mass ratio of 80:20 to 100:0; and a polyglycerol ester of a fatty acid that contains stearic acid and/or behenic acid as a constituent fatty acid. Oiliness and greasiness with respect to paper were reduced in doughnuts, fried dough, French fries, fried chicken, and other foods prepared using the aforementioned oil or fat composition.

Patent Document 2 discloses an oil or fat composition that includes, in specific blending amounts, a palm-based partially hydrogenated oil or fat, a fractionated palm oil hard moiety having an iodine value of 26 to 46, and palm oil. Oiliness and greasiness with respect to paper were reduced in doughnuts, fried dough, French fries, fried chicken, and other foods prepared using the aforementioned oil or fat composition.

Roasted oil is provided with an appetizing flavor by the roasting of raw oil ingredients, and the roasted oil is mixed with rapeseed oil, soybean oil, corn oil, and other such edible oils or fats, and is used as a flavoring for various types of foods. It is also reported (Patent Documents 3 and 4) that roasted oils have an effect in reducing the raw odor and/or off-odor that is characteristic of soybean oil or the like.

### RELATED ART DOCUMENTS

### Patent Documents

[Patent Document 1] Japanese Laid-Open Patent Application No. 2012-19700

[Patent Document 2] Japanese Laid-Open Patent Application No. 2013-243958

[Patent Document 3] Japanese Laid-Open Patent Application No. 2006-204266

[Patent Document 4] International Publication No. 2009/028483

### DISCLOSURE OF THE INVENTION

### Problems to be Solved by the Invention

However, in Patent Documents 1 and 2, hydrogenated oil or fat or an emulsifier is used in order to reduce the oiliness of the doughnuts or the like, and it has been impossible to eliminate the possibility of admixing substances that have an adverse effect on the health aspects of trans-fatty acids or the like.

In addition, roasted oils are not conventionally known to have the effect of reducing the oiliness of cooked foods.

An object of the present invention is therefore to provide, using roasted oil obtained from a roasted raw oil ingredient, an agent for reducing the oiliness of cooked food and a method for reducing the oiliness of cooked food that make it possible to reduce the oiliness of cooked food prepared.

### Means to Solve the Problems

As a result of thoroughgoing research aimed at achieving the aforementioned object, the inventors perfected the present invention upon discovering that roasted oil has the effect of reducing the oiliness of cooked food obtained by using an oil or fat composition in the preparation of the cooked food.

Specifically, the present invention provides an agent for reducing the oiliness of cooked food, characterized by containing roasted oil as an active ingredient.

In the agent for reducing the oiliness of cooked food according to claim 1, the roasted oil is preferably contained in an amount of 0.003% by mass or more to 100% by mass or less.

In the agent for reducing oiliness, the roasted oil is preferably derived from corn or soybeans.

In the agent for reducing oiliness, the roasted oil is preferably refined oil obtained by conducting at least a degumming process and a deacidification process.

In the agent for reducing oiliness, the roasted oil is preferably derived from a raw ingredient that has been roasted at 90° C. or higher to 180° C. or lower, and furthermore is preferably derived from a raw ingredient that has been roasted for more than zero minutes to 90 minutes or less.

In the agent for reducing oiliness, the cooked food is preferably a fried food.

The present invention also provides a method for reducing the oiliness of cooked food, characterized in that the method comprises including roasted oil in a cooking oil or fat composition, applying the same to preparation materials, and conducting cooking.

In the method for reducing the oiliness of cooked food according to the present invention, the roasted oil is preferably included in an amount of 0.003% by mass or more to 10% by mass or less in the cooking oil or fat composition.

In the method for reducing oiliness, the roasted oil is preferably derived from corn or soybeans.

In the method for reducing oiliness, the roasted oil is preferably refined oil obtained by conducting at least a degumming process and a deacidification process.

In the method for reducing oiliness, the roasted oil is preferably derived from a raw ingredient that has been roasted at 90° C. or higher to 180° C. or lower, and furthermore is preferably derived from a raw ingredient that has been roasted for more than zero minutes to 90 minutes or less.

In the method for reducing oiliness, the cooked food is preferably a fried food.

### Advantageous Effects of the Invention

According to the present invention, roasted oil has the effect of reducing the oiliness of a food cooked using an oil or fat composition in which the roasted oil is included.

### BEST MODE FOR CARRYING OUT THE INVENTION

The roasted oil used in the present invention is not subject to any particular limitation and is to be general roasted oil that can be used in foods and is obtained by roasting a raw oil ingredient and then crushing, extracting, or otherwise processing the raw oil ingredient. Examples include roasted oils in which corn (e.g., corn germs), soybeans, sesame, rapeseed, cottonseed, or the like is used as a raw oil ingredient, and which are obtained by roasting the raw oil ingredient and then crushing, extracting, or otherwise processing the raw oil ingredient. One type of roasted oil may be used alone, or two or more types may be used in combination.

As indicated in the examples described below, using corn germs or soybeans as the raw oil ingredient is more preferred because such use is more effective in reducing oiliness. The corn germs used may be obtained by sorting and separating the germ portion from the corn grains according to a dry technique, i.e., may be obtained by a so-called dry milling technique, or may be obtained by sorting and separating the germ portion from the corn grains according to a wet technique, i.e., may be obtained by a so-called wet milling technique. Either of these techniques can be used, although corn germs obtained by the wet milling technique are preferred for use. Examples of the corn germs obtained by the dry milling technique include corn germs obtained as a product of a step that involves grinding corn grains. The steps involved in wet milling can, for example, be as follows. Specifically, the corn grains are first immersed for, e.g., about 48 hours in a diluted solution of sulfurous acid and are allowed to expand. At this time, the protein membrane surrounding an endosperm portion is dissolved by a type of lactic acid fermentation, consequently facilitating separation of the germ portion. The grains are then cracked in such a manner as to avoid destroying the germ portion to the extent possible, at which point the endosperm portion, which contains moisture, settles to a lower part, and the germ portion, which contains a large amount of oil content, collects at an upper part. The difference in specific gravity is therefore utilized to recover the germ portion that has collected at the upper part. The corn germs are obtained by drying the recovered germ portion.

The method for roasting the raw oil ingredient is not subject to any particular limitation but is to be performed using a typical roasting means. A desired raw oil ingredient can, for example, be suitably roasted by a roasting device provided with electric heating, hot blasting, a burner, microwaves, or other heating means. The roasting conditions are to be set appropriately in accordance with the type of raw ingredient. For example, the roasting is preferably conducted at 90° C. or higher to 180° C. or lower, more preferably at 110° C. or higher to 180° C. or lower, even more preferably at 120° C. or higher to 180° C. or lower, yet even more preferably at 140° C. or higher to 180° C. or lower, and particularly preferably at 140° C. or higher to 165° C. or lower. The retention time during roasting is to be set appropriately, may be such that roasting is ended at a point in time when the aforementioned temperatures are reached, and is preferably 90 minutes or less, more preferably more than zero minutes to 90 minutes or less, even more preferably 3 minutes or more to 90 minutes or less, yet even more preferably 5 minutes or more to 90 minutes or less, and particularly preferably 5 minutes or more to 60 minutes or less. As indicated in the embodiments below, when the roasting conditions are too mild, the oiliness-reducing effect tends to be insufficient; conversely, when the roasting conditions are too severe, the roasting tends to become a source that generates a burnt odor.

As the roasted oil used in the present invention, in addition to the way of using raw oil obtained by roasting a raw oil ingredient and then crushing, extracting, or otherwise pressing the raw oil ingredient, roasted oil in the form of refined oil obtained by subjecting the raw oil to a refining process may also be used. Examples of the refining process include degumming, deacidification, bleaching, and deodorization. It is preferable to use refined oil obtained by conducting one or more refining processes from among these, and it is more preferable to use refined oil obtained by conducting at least a degumming process and a deacidification process. Specifically, as indicated in the embodiments below, such refining processes make it possible to reduce a burnt odor originating from the roasting of the raw oil ingredient. It is also possible to remove the aroma, flavor, color, etc., of the roasted raw oil ingredient and to meet the demand in cases in which it is not preferable to have such properties from the raw ingredient.

The degumming process is a step for removing a gummy substance that has phospholipids as a main component by hydrating out from the oil content. The deacidification process is a step for performing a treatment using alkaline water or the like to thereby remove free fatty acids included in the oil content by letting them form soap components. The bleaching process is a step in which pigments included in the oil content are adsorbed out by activated clay or the like. The deodorization process is a step in which odorous components included in the oil content are removed by a treatment such as steam distillation under reduced pressure.

The agent for reducing the oiliness of cooked food according to the present invention (also occasionally referred to simply as “the oiliness-reducing agent” below) contains the roasted oil described above as an active ingredient. The agent is applied to a food being cooked using an oil or fat composition, reducing oiliness. The method for reducing the oiliness of cooked food according to the present invention (also occasionally referred to simply as “the oiliness-reducing method” below) comprises including the roasted oil described above in a cooking oil or fat composition and thereby reducing the oiliness of cooked food obtained by cooking. As used herein, the term “oiliness” does not differ in meaning from the terminology generally understood by consumers and persons skilled in the art; specifically, the term refers to the sensation of stickiness from the oil remaining in the mouth during eating and/or the lingering aftertaste imparted by the oil in the mouth after eating.

In the oiliness-reducing agent according to the present invention, the roasted oil is preferably contained (the total content in cases where two or more roasted oils are used) in an amount of 0.003% by mass or more to 100% by mass or less, more preferably in an amount of 0.01% by mass or more to 100% by mass or less, even more preferably in an amount of 0.1% by mass or more to 80% by mass or less, and yet even more preferably in an amount of 0.1% by mass or more to 50% by mass or less as the active component. Usage of such amounts makes it possible to apply the roasted oil in an effective quantity to cooked food cooked using the oil or fat composition.

In the oiliness-reducing agent according to the present invention, components other than the roasted oil may also be included. In this case, components that are compatible with the roasted oil and have the properties of mediums in which the roasted oil can be readily dispersed are preferred because such components make it easier to mix the agent with an oil or fat composition such as tempura oil or deep-fry oil and to adjust the concentration of the roasted oil. Additive-free roasted oil can also be used in certain situations as an oil or fat composition for cooking foods. Edible oils or fats are preferred as the components other than the roasted oil.

Edible oils or fats other than the roasted oil can be suitably used as the edible oil or fat used in the present invention. Examples include: soybean oil, rapeseed oil, palm oil, corn oil, olive oil, sesame oil, safflower oil, sunflower oil, cottonseed oil, rice bran oil, peanut oil, palm kernel oil, coconut oil, and other such vegetable oils or fats; beef tallow, lard, chicken fat, and other such animal oils or fats; medium-chain fatty acid triglycerides; and processed oils or fats in which the aforementioned oils or fats are fractionated, hydrogenated, transesterified, or otherwise processed. One type of edible oil or fat may be used alone, or two or more types may be used in combination. From the standpoint of the oiliness-reducing effect, it is preferable to use, from among the aforementioned oils and fats, an edible oil or fat having blended therein in an amount of 60% by mass or more of one or more oils or fats selected from soybean oil, rapeseed oil, sunflower oil, palm olein, corn oil, having an iodine value of 50 or higher, and other oils or fats; and it is more preferable to use an edible oil or fat having blended therein in an amount of 80% by mass or more of these oils or fats. It is also preferable to use an edible oil or fat having blended therein in an amount of 60% by mass or more of one or both oils selected from soybean oil and rapeseed oil, and it is more preferable to use an edible oil or fat having blended therein in an amount of 80% by mass or more of these.

The edible oil or fat is preferably one obtained by a process in which a raw oil obtained by crushing, extracting, or other type of pressing from a raw oil ingredient is furthermore subjected to one or more refining processes from among a degumming process, a deacidification process, a bleaching process, and a deodorization process; and is more preferably one obtained by all of the aforementioned refining processes, i.e., the degumming process, the deacidification process, the bleaching process, and the deodorization process. Such refining processes make it possible to remove the aroma, flavor, color, etc., of the raw ingredient and to meet the demand in cases in which it is not preferable to have such properties from the raw ingredient. The definitions of the degumming process, the deacidification process, the bleaching process, and the deodorization process are as set forth in the description relating to the roasted oil.

The edible oil or fat content (the total content in cases where two or more edible oils or fats are used) is preferably more than 0% by mass, more preferably 30% by mass or more, even more preferably 50% by mass or more, yet even more preferably 80% by mass or more, particularly preferably 90% by mass or more, and most preferably 95% by mass or more of the oiliness-reducing agent according to the present invention. No particular upper limit is established, but the total of the roasted oil and the edible oil or fat is 100% by mass or less. The moisture content of the oiliness-reducing agent of the present invention is preferably less than 1% by mass.

An antioxidant, an emulsifier, a flavoring agent, a defoamer, and other such additive materials may also be blended in within a range that does not hinder the effect achieved by the present invention. Specific examples include fatty acid esters of ascorbic acid, lignans, coenzyme Q, γ-oryzanol, tocopherol, and silicone.

Described below are preferred modes of use of the roasted oil as an active component for reducing the oiliness of cooked food in the present invention. This does not mean, however, that the scope of the present invention is limited in any particular way to these modes of use. Specifically, irrespective of the mode of use, any agent can be included in the scope of the present invention as long as agent has the configuration of the roasted oil and is for specific applications such as are described above. Alternatively, any method can be included in the scope of the present invention as long as method has the configuration of the roasted oil and is used for specific applications such as are described above.

According to a preferred mode of the present invention the roasted oil is included in tempura oil, deep-frying oil, or another cooking oil or fat composition, and the composition is applied to cooking materials, making it possible to reduce the oiliness of cooked foods obtained by cooking. In this case, it is the aforementioned edible oil or fat, etc., that can be used as a base oil of the cooking oil or fat composition. The roasted oil content (the total content in cases where two or more roasted oils are used) in the cooking oil or fat composition is preferably 0.003% by mass or more to 10% by mass or less, more preferably 0.01% by mass or more to 5% by mass or less, even more preferably 0.03% by mass or more to 5% by mass or less, yet even more preferably 0.1% by mass or more to 5% by mass or less, and particularly preferably 0.3% by mass or more to 5% by mass or less. Such usage makes it possible to apply the roasted oil in an effective quantity to cooked food cooked using the oil or fat composition, and also to meet the demand in cases where the aroma, flavor, color, and other such properties of the roasted oil are not preferred.

The present invention can preferably be applied to cooked foods comprising tempura, French fries, hash browns, croquettes, deep-fried meat and fish, fried pork cutlets, fried fish, corn dogs, chicken nuggets, fried tofu, doughnuts, fried dough, croutons, fried rice crackers, snack foods, instant ramen, and other such fried foods. In particular, products to which the present invention can be applied more preferably include cooked foods obtained using batter, such tempura, and cooked foods obtained using bread crumbs, such croquettes. The modes for preparing cooked foods are not subject to any particular limitation, and cooking is to be conducted in the present invention in an appropriate manner in accordance with the desired mode by methods suitable for a variety of cooked foods in accordance with the type of cooked food, using the roasted oil as an active component for reducing the oiliness of the cooked foods. Specifically, the roasted oil, or the oiliness-reducing agent containing the roasted oil, is to be used to fry or otherwise cook prescribed preparation materials for a cooked food under conditions in which the temperature is typically set to 140 to 200° C., and is more typically set to 150 to 190° C.

### EXAMPLES

The present invention is described in greater detail below by way of examples, but these examples do not in any way of any limit the present invention.

(Roasted Oil)

Table 1 shows the roasted oils used.

TABLE 1

| | Raw | Roasting conditions and oil pressing |
|---|---|---|
| | ingredient | method |
| Roasted | Soybeans | Unprocessed soybeans were roasted for 30 |
| soybean oil | | min at 150° C. and then crushed. |
| Roasted | Rapeseed | Unprocessed rapeseed was roasted for 30 |
| rapeseed oil | | min at1 50° C. and then crushed. |
| Roasted | Cottonseed | Cottonseed was pulverized by hitting with |
| cottonseed | | a hammer, subsequently roasted for 30 min |
| oil | | at 150° C., and then extracted using |
| | | hexane. |
| Roasted | Sesame | Commercial roasted sesame oil (product |
| sesame oil | | name “Gomasuki no gomayu,” made by |
| | | J-Oil Mills Inc.; roasted sesame was |
| | | crushed). |
| Roasted corn | Corn germs | Corn germs obtained by wet milling were |
| oil (W) | (wet) | roasted for 30 min at 150° C. and then |
| | | crushed. |
| Roasted corn | Corn germs | Corn germs obtained by dry milling were |
| oil (D) | (dry) | roasted for 30 min at 150° C. and then |
| | | crushed. |

The roasting was conducted using a roasting device provided with a gas burner as a heating means.

In addition to raw oils crushed or extracted from the raw oil ingredients, optionally refined oils or fats were furthermore prepared as roasted oils, as shown in table 2.

TABLE 2

| | | Refining steps | | | | |
|---|---|---|---|---|---|---|
| | Refining | Crushing/ | | | | |
| | state | extraction | Degumming | Deacidification | Bleaching | Deodorization |
| Roasted | Pressed | ◯ | — | — | — | — |
| soybean | Degummed | ◯ | ◯ | — | — | — |
| oil | Deacidified | ◯ | ◯ | ◯ | — | — |
| | Bleached | ◯ | ◯ | ◯ | ◯ | — |
| | Deodorized | ◯ | ◯ | ◯ | ◯ | ◯ |
| Roasted | Pressed | ◯ | — | — | — | — |
| rapeseed oil | Degummed | ◯ | ◯ | — | — | — |
| Roasted | Pressed | ◯ | — | — | — | — |
| cottonseed oil | Degummed | ◯ | ◯ | — | — | — |
| Roasted | Pressed | ◯ | — | — | — | — |
| sesame oil | Degummed | ◯ | ◯ | — | — | — |
| Roasted | Pressed | ◯ | — | — | — | — |
| corn oil | Degummed | ◯ | ◯ | — | — | — |
| (W) | Deacidified | ◯ | ◯ | ◯ | — | — |
| | Bleached | ◯ | ◯ | ◯ | ◯ | — |
| | Deodorized | ◯ | ◯ | ◯ | ◯ | ◯ |
| Roasted | Deodorized | ◯ | ◯ | ◯ | ◯ | ◯ |
| corn oil (D) | | | | | | |

(The “◯” symbols indicate how far refinement has progressed in the preparation of roasted oils.)

(Cooked Food)

Fried foods were prepared as cooked foods in the manner described below.

(1) Deep-fried flour batter: Tempura batter mix (product name “Kotsu no iranai tempurako,” manufactured by Nisshin Foods Inc.) was used to prepare a batter, and the batter was fried for three minutes at 170° C.

(2) Fish fingers: Frozen fish fingers (manufactured by Yachiyo Corp.) were fried for three minutes at 170° C.

(3) Croquettes: Frozen croquettes (product name “NEW potato korokke,” manufactured by Ajinomoto Frozen Food Co., Inc.) were fried for three minutes at 170° C.

(4) Croutons: Sandwich bread (product name “Chojuku sandwich yo,” manufactured by Pasco Shikishima Corp.) was diced to a size of about 2 cm per side, and the diced bread was fried for 20 seconds at 170° C.

(Evaluation)

Conditions such as those employed in a repeated preparation in an industrial application were simulated, test oil was heated for five hours at 180° C., the cooked foods were subsequently prepared in the test oil, and the oiliness and burnt odor during consumption of the resulting cooked foods were evaluated. The evaluations were conducted by two expert panelists who followed the evaluation criteria given below and made comparisons with cooked foods in a case involving preparation using a base oil to which no roasted oil was added. The two panelists assigned scores after reaching an agreement.

<Evaluation of Oiliness>

5: Oiliness greatly reduced

4: Oiliness quite reduced

3: Oiliness reduced

2: Oiliness somewhat reduced

1: Oiliness not reduced

<Evaluation of Burnt Odor>

5: Burnt odor very weak or imperceptible

4: Burnt odor weak

3: Burnt odor somewhat weak

2: Burnt odor strong

1: Burnt odor very strong

### Test Example 1

An oil in which 3 ppm of silicone was included as a defoamer in canola oil (manufactured by J-Oil Mills Inc.; subjected to a degumming process, a deacidification process, a bleaching process, and a deodorization process; same below) was used as a base oil, and the roasted oils described above were added to the base oil so as to reach a concentration of 0.3% by mass, thus forming test oils. Deep-fried flour batter, fish fingers, or croquettes were prepared using the test oils, and the oiliness and burnt odor during consumption of the resulting cooked foods were evaluated. The preparation and evaluation of the cooked foods were conducted as described above.

The results are shown in table 3.

TABLE 3

| Base oil: canola oil | | Evaluation (score) | | | | | |
|---|---|---|---|---|---|---|---|
| (with silicone added) | | Oiliness | | | Burnt odor | | |
| Roasted oil added | Refining | Deep-fried | Fish | | Deep-fried | Fish | |
| (0.3% by mass) | state | flour batter | fingers | Croquettes | flour batter | fingers | Croquettes |
| Roasted | Pressed | 5 | 5 | 4 | 1 | 4 | 4 |
| corn oil | Degummed | 5 | 5 | 4 | 1 | 4 | 4 |
| (W) | Deacidified | 5 | 5 | 4 | 3 | 5 | 5 |
| (corn germs | Bleached | 5 | 5 | 4 | 5 | 5 | 5 |
| (wet)) | Deodorized | 5 | 5 | 4 | 5 | 5 | 5 |
| Roasted | Pressed | 4 | 3 | n.d. | 1 | 3 | n.d. |
| soybean | Degummed | 4 | 3 | | 1 | 3 | |
| oil | Deacidified | 3 | 3 | | 3 | 4 | |
| | Bleached | 3 | 3 | | 4 | 5 | |
| | Deodorized | 3 | 3 | | 5 | 5 | |
| Roasted | Pressed | 2 | 2 | n.d. | 1 | 1 | n.d. |
| sesame oil | Degummed | 2 | 2 | | 1 | 1 | |
| Roasted | Pressed | 2 | n.d. | n.d. | 1 | n.d. | n.d. |
| rapeseed oil | Degummed | 2 | | | 1 | | |
| Roasted | Pressed | 2 | n.d. | n.d. | 1 | n.d. | n.d. |
| cottonseed oil | Degummed | 2 | | | 1 | | |

(n.d.: Indicates that no test was performed)

As a result, oiliness was reduced to a greater extent in cases where 0.3% by mass of roasted oil was blended into canola oil, and where deep-fried flour batter, fish fingers, and croquettes were cooked using the resulting test oil, than in cases where no roasted oil was blended in. In particular, the oiliness-reducing effect was high when roasted oil derived from soybeans or from corn germs obtained by wet milling was used, and the effect was particularly pronounced in the case of the roasted oil derived from corn germs. In addition, as can be observed from the results of evaluating the burnt odor in the deep-fried flour batter, it is apparent that when the roasted oil is in the form of refined oil obtained by conducting at least a degumming process and a deacidification process, the burnt odor is further reduced than when the roasted corn oil is in the pressed form obtained by crushing alone, while the oiliness-reducing effect remains unchanged.

### Test Example 2

An oil in which 3 ppm of silicone was included as a defoamer in canola oil was used as a base oil, and the roasted corn oil (W) (corn germs (wet)) (refining state: deodorized) described above was added to the base oil so that the concentration thereof in the base oil was changed to 0.003% by mass, 0.03% by mass, 0.3% by mass, 0.5% by mass, 1% by mass, 3% by mass, or 5% by mass, thus forming test oils. Deep-fried flour batter was prepared using the test oils, and the oiliness and burnt odor during consumption of the resulting deep-fried flour batter were evaluated. The preparation and evaluation of the cooked foods were conducted as described above.

The results are shown in table 4.

TABLE 4

| | | Evaluation (score) | |
|---|---|---|---|
| Base oil: canola oil (with silicone | | Oiliness | Burnt odor |
| added) | | Deep-fried | Deep-fried |
| Roasted oil added | Concentration | flour batter | flour batter |
| Roasted corn oil (W) | 0.003% by mass | 3 | 5 |
| (corn germs (wet)) | 0.03% by mass | 4 | 5 |
| Refining state: | 0.3% by mass | 5 | 5 |
| deodorized | 0.5% by mass | 5 | 5 |
| | 1% by mass | 5 | 5 |
| | 3% by mass | 5 | 5 |
| | 5% by mass | 5 | 5 |

As a result, an oiliness-reducing effect was observed even when the roasted oil derived from corn germs obtained by wet milling was blended in an amount of 0.003% by mass.

### Test Example 3

An oil in which 3 ppm of silicone was included as a defoamer in canola oil was used as a base oil, and the roasted soybean oil (refining state: deodorized) described above was added to the base oil so that the concentration of the roasted soybean oil in the base oil was changed to 0.3% by mass, 0.5% by mass, 1% by mass, 3% by mass, or 5% by mass, thus forming test oils. Deep-fried flour batter or fish fingers were prepared using the test oils, and the oiliness and burnt odor during consumption of the resulting cooked foods were evaluated. The preparation and evaluation of the cooked foods were conducted as described above.

The results are shown in table 5.

TABLE 5

| Base oil: canola oil (with | | Evaluation (score) | | | |
|---|---|---|---|---|---|
| silicone added) | | Oiliness | | Burnt odor | |
| Roasted | | Deep-fried | | Deep-fried | |
| oil | | flour | Fish | flour | Fish |
| added | Concentration | batter | fingers | batter | fingers |
| Roasted | 0.3% by mass | 3 | 3 | 5 | 5 |
| soybean | 0.5% by mass | 3 | 3 | 5 | 5 |
| oil | 1% by mass | 3 | 3 | 5 | 5 |
| Refining | 3% by mass | 3 | 3 | 5 | 5 |
| state: | 5% by mass | 3 | 3 | 5 | 5 |
| deodorized | | | | | |

As a result, an oiliness-reducing effect was observed when the soybean-derived roasted oil was blended in an amount of 0.3% by mass or more.

### Test Example 4

Canola oil that was high in oleic acid and low in linoleic acid (manufactured by J-Oil Mills Inc.; subjected to a degumming process, a deacidification process, a bleaching process, and a deodorization process; referred to as “HOLL” below) was used as a base oil, and roasted corn oil (W) in the various refining states described above was added to the base oil so as to reach a concentration of 0.3% by mass, thus forming test oils. Deep-fried flour batter was prepared using the test oils, and the oiliness and burnt odor during consumption of the resulting deep-fried flour batter were evaluated. The preparation and evaluation of the cooked foods were conducted as described above.

The results are shown in table 6.

TABLE 6

| | | Evaluation (score) | |
|---|---|---|---|
| Base oil: HOLL | | Oiliness | Burnt odor |
| Roasted oil added | Refining | Deep-fried | Deep-fried |
| (0.3% by mass) | state | flour batter | flour batter |
| Roasted corn oil (W) | Deacidified | 5 | 4 |
| (corn germs (wet)) | Bleached | 5 | 5 |
| | Deodorized | 5 | 5 |

As a result, similar to the cases where canola oil was used as the base oil in test examples 1 to 3, an oiliness-reducing effect derived from the roasted oil was observed even when HOLL was used as a base oil. It was also understood that roasted oil that has undergone a bleaching step is preferred in view of a low burnt odor.

### Test Example 5

Canola oil was used as a base oil, and the roasted corn oil (W) (refining state: pressed) described above was added to the base oil so as to reach a concentration of 0.3% by mass, thus forming a test oil. Croutons were prepared using the base oil, and the oiliness and burnt odor during consumption of the resulting croutons were evaluated. The preparation and evaluation of the cooked foods were conducted as described above.

The results are shown in table 7.

TABLE 7

| | | Evaluation (score) | |
|---|---|---|---|
| Base oil: canola oil (silicone-free) | | Oiliness | Burnt odor |
| Roasted oil added | Refining state | Croutons | Croutons |
| Roasted corn oil | Pressed | 5 | 1 |
| (W) (corn germs | | | |
| (wet)) | | | |

As a result, oiliness was reduced by the roasted oil in the croutons as well. However, because the roasted oil was pressed oil obtained by crushing alone, the occurrence of a burnt odor was pronounced.

### Test Example 6

A mixed oil obtained by mixing 50 parts by mass of canola oil and 50 parts by mass of soybean oil (manufactured by J-Oil Mills Inc.; subjected to a degumming process, a deacidification process, a bleaching process, and a deodorization process) was used as a base oil, and the roasted corn oil (W) (refining state: deodorized) described above was added to the base oil so as to reach a concentration of 0.3% by mass, thus forming a test oil. Deep-fried flour batter, fish fingers, or croquettes were prepared using the test oil, and the oiliness and burnt odor during consumption of the resulting cooked foods were evaluated. The preparation and evaluation of the cooked foods were conducted as described above.

The results are shown in table 8.

TABLE 8

| Base oil: canola | | | | | | | |
|---|---|---|---|---|---|---|---|
| oil/soybean | | Evaluation (score) | | | | | |
| oil = 50/50 | | Oiliness | | | Burnt odor | | |
| Roasted oil added | Refining | Deep-fried | Fish | | Deep-fried | Fish | |
| (0.3% by mass) | state | flour batter | fingers | Croquettes | flour batter | fingers | Croquettes |
| Roasted | Deodorized | 5 | 5 | 4 | 5 | 5 | 5 |
| corn oil (W) | | | | | | | |
| (corn germs (wet)) | | | | | | | |

As a result, similar to the cases where canola oil was used as the base oil in test examples 1 to 3 and to the case where HOLL was used as the base oil in test example 4, an oiliness-reducing effect derived from the roasted oil was observed even when a mixed oil obtained by mixing canola oil and soybean oil was used as the base oil.

### Test Example 7

Canola oil was used as a base oil, and the roasted corn oil (W) (refining state: deodorized) described above was added to the base oil so as to reach a concentration of 0.3% by mass, thus forming a test oil. Deep-fried flour batter, fish fingers, or croquettes were prepared using the test oil, and the oiliness and burnt odor during consumption of the resulting cooked foods were evaluated. The preparation and evaluation of the cooked foods were conducted as described above.

The results are shown in table 9.

TABLE 9

| Base oil: canola | | Evaluation (score) | | | | | |
|---|---|---|---|---|---|---|---|
| oil (silicone-free) | | Oiliness | | | Burnt odor | | |
| Roasted oil added | Refining | Deep-fried | Fish | | Deep-fried | Fish | |
| (0.3% by mass) | state | flour batter | fingers | Croquettes | flour batter | fingers | Croquettes |
| Roasted | Deodorized | 5 | 5 | 4 | 5 | 5 | 5 |
| corn oil (W) | | | | | | | |
| (corn germs(wet)) | | | | | | | |

As a result, similar to the cases where canola oil (containing silicone as a defoamer) was used as the base oil in test examples 1 to 3, an oiliness-reducing effect derived from the roasted oil was observed even when canola oil not containing silicone as a defoamer was used as a base oil.

### Test Example 8

A mixed oil of roasted corn oil was prepared as roasted oil by mixing 80 parts by mass of the roasted corn oil (W) (refining state: deodorized) described above and 20 parts by mass of roasted corn oil (D) (refining state: deodorized).

An oil in which 3 ppm of silicone was included as a defoamer in canola oil was used as a base oil, and the mixed oil (refining state: deodorized) of roasted corn oil described above was added to the base oil so as to reach a concentration of in the 0.03% by mass, 0.3% by mass, 1% by mass, 3% by mass, or 5% by mass, thus forming test oils. Deep-fried flour batter, fish fingers, or croquettes were prepared using the test oils, and the oiliness and burnt odor during consumption of the resulting cooked foods were evaluated. The preparation and evaluation of the cooked foods were conducted as described above.

The results are shown in table 10.

TABLE 10

| Base oil: canola | | | Evaluation (score) | | | | | |
|---|---|---|---|---|---|---|---|---|
| oil (with silicone added) | | | Oiliness | | | Burnt odor | | |
| Roasted | | | Deep-fried | Fish | | Deep-fried | Fish | |
| oil added | Concentration | | flour batter | fingers | Croquettes | flour batter | fingers | Croquettes |
| Roasted corn oil | 0.03% | by mass | 3 | n.d. | n.d. | 5 | n.d. | n.d. |
| (W)/roasted | 0.3% | by mass | 5 | 4 | 3 | 5 | 5 | 5 |
| corn oil | 1% | by mass | 5 | 5 | 4 | 5 | 5 | 5 |
| (D) = 80/20 | 3% | by mass | 5 | 5 | 4 | 5 | 5 | 5 |
| Refining state: | 5% | by mass | 5 | 5 | 4 | 5 | 5 | 5 |
| deodorized | | | | | | | | |

(n.d.: Indicates that no test was performed)

As a result, similar to the cases in which a roasted oil derived from corn germs obtained by wet milling was used alone as the roasted oil, an oiliness-reducing effect derived from the roasted oil was observed even when the roasted oil derived from corn germs obtained by dry milling was used in combination.

### Test Example 9

In lieu of the roasted corn oil (W) described above, i.e., the roasted oil (refining state: pressed) obtained by roasting wet-milled corn germs for 30 minutes at 150° C. and then crushing the corn germs, as roasted oil in use, roasted corn oil (W) (refining state: pressed) obtained by arbitrarily varying the roasting conditions as shown in table 11 and using wet-milled corn germs as raw oil ingredients was used.

An oil in which 3 ppm of silicone was included as a defoamer in canola oil was used as a base oil, and the roasted corn oil (refining state: pressed) described above was added to the base oil so as to reach a concentration of 0.3% by mass, thus forming a test oil. The oiliness and burnt odor during consumption of cooked foods were otherwise evaluated in the same manner as in test example 1. For the sake of comparison, tests were also conducted in the same manner on non-roasted corn oil (refining state: pressed) that was obtained from wet-milled corn germs by crushing and pressing the corn germs without conducting a roasting process.

The results are shown in table 11.

TABLE 11

| Base oil: canola oil | | | | Evaluation (score) | | | | | |
|---|---|---|---|---|---|---|---|---|---|
| (with silicone added) | | | | Oiliness | | | Burnt odor | | |
| Roasted oil added | Roasting | Roasting | | Deep-fried | Fish | | Deep-fried | Fish | |
| (0.3% by mass) | temp. | time | | flour batter | fingers | Croquettes | flour batter | fingers | Croquettes |
| Roasted | — | 0 | min | 1 | 1 | 1 | 5 | 5 | 5 |
| corn oil | 90° C. | 5 | min | 3 | n.d. | n.d. | 5 | n.d. | n.d. |
| (W) | | 30 | min | 3 | | | 5 | | |
| obtained | | 60 | min | 3 | | | 4 | | |
| under | | 90 | min | 3 | | | 4 | | |
| various | 120° C. | 5 | min | 3 | n.d. | n.d. | 3 | n.d. | n.d. |
| roasting | | 30 | min | 3 | | | 3 | | |
| conditions | | 60 | min | 3 | | | 3 | | |
| Refining | | 90 | min | 3 | | | 3 | | |
| state: | 150° C. | 5 | min | 4 | 4 | 3 | 4 | 5 | 5 |
| pressed | | 15 | min | 4 | 5 | 4 | 4 | 5 | 5 |
| | | 30 | min | 5 | 5 | 4 | 1 | 4 | 4 |
| | | 60 | min | 5 | 5 | 5 | 1 | 4 | 4 |
| | | 90 | min | 5 | 5 | 5 | 1 | 4 | 4 |
| | 180° C. | 5 | min | 4 | 4 | 3 | 4 | 4 | 4 |
| | | 30 | min | 5 | 5 | 4 | 3 | 4 | 4 |
| | | 60 | min | 5 | 5 | 5 | 1 | 3 | 3 |
| | | 90 | min | 5 | 5 | 5 | 1 | 1 | 1 |

(n.d.: Indicates that no test was performed)

As a result, no oiliness-reducing effect was obtained when the raw oil ingredient was not roasted. Moreover, it was apparent that when the roasting conditions are too severe, the roasting tends to become a source that generates a burnt odor.

### Test Example 10

An oil in which 3 ppm of silicone was included as a defoamer in canola oil was used as a base oil, and the roasted corn oil (W) (corn germs (wet)) (refining state: deodorized) described above was added to the base oil so as to reach a concentration of 0.4% by mass, thus forming a test oil. An oil in which 3 ppm of silicone was included as a defoamer in canola oil was used as a control oil.

The test oil and the control oil were used to fry deep-fried flour batter, and the oiliness during consumption was evaluated. The deep-fried flour batter was prepared by using the tempura batter mix (product name “Kotsu no iranai tempurako,” manufactured by Nisshin Foods Inc.) described above to produce a batter and then frying the batter for three minutes at 180° C. The evaluations were conducted by expert panelists in the numbers shown in table 12. The evaluations were conducted for the test oil and the control oil immediately after the oils were heated to 180° C. and 32 hours after the oils were heated to 180° C. The panelists assigned scores in six levels in accordance with the evaluation criteria given below. The average score and the standard deviation of the assigned scores were calculated, and a significance test was furthermore conducted according to the Wilcoxon test.

(Evaluation Criteria)

5: Highly pronounced oiliness

4: Pronounced oiliness

3: Somewhat low oiliness

2: Low oiliness

1: Extremely low oiliness

0: No discernible oiliness

The results are shown in table 12.

TABLE 12
Base oil: canola oil (with silicone added)

| Roasted oil | Presence | Oil or | Evaluation | No. of expert | Evaluation | |
|---|---|---|---|---|---|---|
| used (0.4% by mass) | of additive | fat used | period | pane-lists | Average score | Standard deviation |
| Roasted corn oil | − | Control oil | Immediately after | 10 | 3.40 | 1.26 |
| (W) (corn germs | + | Test oil | heating to 180° C. | | 2.20 | 1.11 |
| (wet)) Refining | − | Control oil | 32 hours after | 15 | 3.67 | 0.62 |
| state: deodorized | + | Test oil | heating to 180° C. | | 2.53 | 1.25 |

As a result, in cases where the oils were evaluated at along the same evaluation period, the oiliness was suppressed to a greater extent in deep-fried flour batter that was fried using test oil to which roasted corn oil was added. This was in comparison with deep-fried flour batter that was fried using control oil to which no roasted corn oil was added. According to the results of the significance test, the level of significance between the control oil and the test oil immediately after the oils were heated to 180° C. was 1%, and thus there was a significant difference between the two oils. The level of significance between the control oil and the test oil 32 hours after the oils were heated to 180° C. was 5%, and thus there was a significant difference here as well.

1. An agent for reducing the oiliness of cooked food, characterized by containing roasted oil as an active component.

2. The agent for reducing the oiliness of cooked food according to claim 1, wherein the roasted oil is contained in an amount of 0.003% by mass or more to 100% by mass or less.

3. The agent for reducing the oiliness of cooked food according to claim 1, wherein the roasted oil is derived from corn or soybeans.

4. The agent for reducing the oiliness of cooked food according to claim 1, wherein the roasted oil is refined oil obtained by conducting at least a degumming process and a deacidification process.

5. The agent for reducing the oiliness of cooked food according to claim 1, wherein the roasted oil is derived from a raw ingredient that has been roasted at 90° C. or higher to 180° C. or lower.

6. The agent for reducing the oiliness of cooked food according to claim 5, wherein the roasted oil is derived from a raw ingredient that has been roasted for more than zero minutes to 90 minutes or less.

7. The agent for reducing the oiliness of cooked food according to claim 1, wherein the cooked food is a fried food.

8. A method for reducing the oiliness of cooked food, characterized in that the method comprises including roasted oil in a cooking oil or fat composition, applying the same to preparation materials, and conducting cooking.

9. The method for reducing the oiliness of cooked food according to claim 8, wherein the roasted oil is included in an amount of 0.003% by mass or more to 10% by mass or less in the cooking oil or fat composition.

10. The method for reducing the oiliness of cooked food according to claim 8, wherein the roasted oil is derived from corn or soybeans.

11. The method for reducing the oiliness of cooked food according to claim 8, wherein the roasted oil is refined oil obtained by conducting at least a degumming process and a deacidification process.

12. The method for reducing the oiliness of cooked food according to claim 8, wherein the roasted oil is derived from a raw ingredient that has been roasted at 90° C. or higher to 180° C. or lower.

13. The method for reducing the oiliness of cooked food according to claim 12, wherein the roasted oil is derived from a raw ingredient that has been roasted for more than zero minutes to 90 minutes or less.

14. The method for reducing the oiliness of cooked food according to claim 8, wherein the cooked food is a fried food.
